(19) United States
(12) Patent Application Publication
(10) Pub. No.: US 2026/0165292 A1
(43) Pub. Date: Jun. 18, 2026

(54) METHOD FOR A DIRECTED ANIMAL TRAFFIC, AND MILKING INSTALLATION

(71) Applicant: GEA Farm Technologies GmbH, Bönen (DE)

(72) Inventors: Michael Strotmann, Billerbeck (DE); Johannes Otteloh, Ahlen (DE)

(21) Appl. No.: 18/710,480

(22) PCT Filed: Oct. 27, 2022
(86) PCT No.: PCT/EP2022/080067

§ 371 Date: May 15, 2024

(30) Foreign Application Priority Data
Nov. 19, 2021 (DE) 10 2021 130 324.9

(51) Int. Cl. A01K 1/12; A01K 1/00; A01K 29/00

(52) U.S. Cl. CPC A01K 1/126; A01K 1/0029; A01K 29/005

(57) ABSTRACT

The invention relates to a method for controlling the flow of traffic of animals (1), said method being carried out at least partially automatedly, and to a milking installation which has the method features. On the basis of the animal density in at least one specifiable detection region (2.1, 2.2), a directing unit (4) can be automatically adjusted according to the method, said directing unit allowing, facilitating, or preventing the passage of the animals through a corridor (8). According to advantageous embodiments, the operation of a cow pusher and a carousel milking station is also controlled on the basis of the detected data.

The invention relates to a method for directed animal traffic and to a milking installation.

In agricultural concerns, animals must often more or less independently travel distances between various regions. In many cases, for example, the animals are trained or themselves feel a need to go to feeding stations or milking devices. In order to facilitate and possibly assist these processes, various aids and traffic guiding systems are known. For instance, WO 2015/177269 A 1 discloses a device for directed animal traffic which is combined with a milking parlor. A milking parlor preferably has a plurality of milking stalls with automatic milking systems (AMS), which preferably operate fully automatically. It is also possible for a milking parlor to comprise at least one semiautomatic or manual milking region. Animals may in particular seek out a milking parlor individually or while being driven in groups of animals.

Particularly in the case of directed animal traffic, it is customary to drive animals in one direction for example with the aid of cow drivers or acoustic and/or optical signals. These processes are usually initiated purposely by staff. For this purpose, it is first necessary to observe in which regions of the concern animals are present and how many animals are present in them and what traffic flow is desired, for example a traffic flow toward a milking parlor. The staff may thereupon initiate appropriate measures, call or purposely attract or drive individual animals, and open or close gates. This must be done simultaneously alongside further operating procedures such as milking and cleaning processes.

Since directed animal traffic to a predetermined region, in particular a milking region, usually requires active intervention by the staff, it entails an increased staff workload or an increased staff cost.

Furthermore, animals in a herd or group of animals have different rankings. Depending on the ranking of the animal, lower-ranking animals behave differently when encountering a higher-ranking animal.

With a view to directed animal traffic, it is desirable to initiate particular actions with the aid of measurable parameters. For example, where there are particularly many animals in a constricted space, a possibility may be provided that at least some animals can leave this region so that the situation is eased.

The object of the present invention is to at least partially overcome the disadvantages known from the prior art. This object is achieved by the features of the independent claims. The dependent claims relate to advantageous developments.

By the automatic recognition of a very wide variety of scenarios with the aid of the proposed method, a specific measure may be initiated automatically. Such a scenario may for example be congestion in one region and an associated backup of cows, while there is a great deal of space between the cows in another region. A further scenario is a generally low animal density, which may for example result in animals feeling no urge to leave a holding area.

One measure is to deliberately allow or prevent a traffic flow. This is achieved by a steering unit, which is arranged in a passage through which the animals need to go, being brought into a particular position. This achieves the effect that the animals are held back in a region upstream of the passage or can rapidly leave this region. The situation-specific adjustment of the steering unit may take place without intervention by staff.

A parameter for evaluating the scenario may be based on an animal density, that is to say a number of animals that are present over a particular area. The animal density must first be recorded. For this purpose, recording regions in which the number of animals are recorded may be defined. A recording region may be configured to be static-for example in the region of a transition between a holding area and a passage-or dynamic-for example a constant number of square meters in front of a moving cow driver.

The method provides possibilities for measuring an animal density, which may be applied individually or in combination in order to influence the animal traffic at least semi-automatically on the basis of the data. For this purpose, a recording unit, which may be combined with further recording units, is respectively employed. Recording units may be optical or wireless electronic systems. Furthermore, a recording unit may for example be formed by a plurality of treading sensors.

With an optical recording system, which may for example be a camera, a laser system or a recording system based on photocell technology, it is possible to record where and how many animals there are in a monitored region. This option is economical, and retrofitting is possible without great expense.

Another preferred possibility consists in wireless electronic recording of the position of each individual animal by recognizing an identification means that is worn by each animal. Beyond ascertaining an animal density, this possibility offers the advantage that it is possible to recognize accurately which animal is where. It is customary that livestock in agricultural concerns already wear corresponding identification means for other purposes, which comprise for example acceleration sensors, in order to deduce an activity of an animal. With the aid of the identification means, feeding and rumination times as well as the duration of other activities may be documented. For the method proposed here, these identification means could be employed in another way. With the aid of this system, which according to the comments above is sometimes already present in the concerns, specific parameters, for example a “milking readiness”, may also be taken into account in the calculation of the installation control and traffic guidance. Milking readiness is a parameter relating to the instant when a cow within a group usually enters the milking installation.

A further possibility for the recording consists in the floor containing treading sensors, with the aid of which a number of loadings or load levels may be ascertained. A number of animals in the recording region may be ascertained on the basis thereof.

In the recording methods explained above, the animal density may respectively be identified discontinuously, that is to say at an individual instant or repeatedly after freely selectable time intervals. Each recording may also be triggered by a limit value being reached. For example, as a function of the last-ascertained animal density it is possible to determine after how many seconds or minutes the next recording should take place. Further, a recording may be initiated as a function of a quantity of milk obtained or a number of animals processed.

Likewise, the recording may take place in real time, that is to say continuously. In the case of continuous recording, when using a camera or another optical method, a video may be compiled and constantly analyzed. In the case of recording by means of an animal detection device or treading sensors, the position of each animal may also be constantly identified and a shift of the animal density in any direction in a monitored region may thus be recognized.

In order to connect two regions in an agricultural concern, a passage delimited on two sides may be formed. This must have a certain width so that each animal can pass through it without touching the sides. For very thin animals, in a passage that is too wide it is possible for two or more animals to move side by side through the passage. In many cases, however, for example before a milking parlor, separation of the animals is desired. It is therefore advantageous to integrate a steering unit into the passage, with which a width of the passage can be adapted to the animals that are intended to pass through the passage. For this purpose, for example, a frame-like construction that can be adjusted manually or by a control device may be rotatably mounted or displaceably installed in a lateral barrier element.

According to the proposed method, the opening angle of a steering unit arranged in a passage may be influenced. It is also possible to completely bar the passage or open it as wide as possible. It should be possible for this to take place without staff having to intervene. The opening angle may furthermore be determined not only as a function of the animal size, but also as a function of other parameters such as an animal density or installation parameters. The installation parameters may, for example, be a rotational speed of a milking carousel and/or a rate of advance of a cow driver. The latter is often used to move animals in a particular direction. It may be a grid-like structure which can be moved to and fro along an imaginary axis and is suitable and intended for driving animals in the direction in which it is moved. The cow driver is designed in such a way that the animals cannot return past it counter to the driving direction. If there is a cow driver in the concern, an operating characteristic and in particular a rate of advance of the cow driver should also be regulatable on the basis of the recorded data.

Furthermore, a rotational speed of a milking carousel should also be variable as a function of the acquired data.

The advantages of the invention may be used in the scope of the husbandry and treatment of animals in various contexts. With the aid of the invention, for example, the traffic flow of cows that are moving to a milking parlor may be organized and adapted in an at least semi-automated fashion to current scenarios. The invention is not, however, restricted to this possible application. It may advantageously be used for various processes with a view to a milking or treatment process for cows, sheep, buffalo, goats or other animals producing milk.

The invention is intended to be a contribution to a largely digitally controlled operation having a reduced staff requirement with a high operating reliability. The monitoring of the animal flow and a flow regulation in the entry region of milking carousels, milking parlors and treatment stations are improved by the invention. Improved capacity utilization of all devices is also achieved by the method according to the invention.

In the method according to the invention for influencing a traffic flow of animals in a holding area, which may be divided into a plurality of recording regions, and in a passage adjacent to the holding area, wherein a width of the passage can be adjusted by the setting of a steering unit, a plurality of method steps are carried out.

First, how many animals there are in a predeterminable recording region is recorded. This may for example be part of a holding area where cows to be milked wait before they go to the milking parlor. Such holding areas may also be formed in front of treatment stations, for example footbaths, which the animals should enter as far as possible individually and in an orderly fashion. For leaving the holding area, it is followed by a passage. The traffic flow in the holding area, when the animals enter the passage and in the passage itself, should be capable of being influenced by this method. For this purpose, the passage comprises lateral barriers, at least one of which has an adjustable steering unit. The width of the passage may be varied by adjusting the steering unit.

In what follows, a distinction is made between an actual opening extent and a setpoint opening extent of a steering unit. The actual opening extent refers to an opening extent of the steering unit adjusted at the moment of observation. The setpoint opening extent refers to an ascertained opening extent of the steering unit that is to be adjusted.

As a function of the ascertained number of animals in the recording region, a density (animals/area) may be calculated. This may take place in a data processing system. With the aid of the recorded and processed data, it is possible to ascertain whether the animals are backing up, pushing in the direction of the passage, or standing very far apart from one another. A passage width, and as a function of this the setpoint opening extent of the at least one steering unit, are determined on the basis thereof.

In the example of a milking installation, a setpoint opening extent may also be determined as a function of an expected milking throughput (cows milked/time). For example, this may achieve the effect that the animals can pass more easily through the passage or are held back.

In a further step, the setpoint opening extent is compared with the actual opening extent. If the result is that the setpoint opening extent is different, a command may be issued to a control device of the steering unit and the steering unit may be moved to the setting that has been determined. It is also possible to establish tolerance ranges, so that the steering unit is not adjusted in the event of small differences between the setpoint and actual opening extents.

It is particularly advantageous for a recording region to comprise the transition region between the holding yard and the passage, since the situation at this location provides information as to whether the animals are already congested before entering the passage or there are free spaces there. In the event of a backup in front of the passage, the steering unit may be brought into a predeterminable setting. If there are many animals crowded in front of the steering unit, the latter may be fully opened in order to let the animals escape and reduce the risk of panic breaking out.

According to another advantageous embodiment, the number of animals is not only recorded in one recording region. A higher data yield may be achieved by determining a plurality of recording regions and calculating an animal density for each region, and comparing the data with one another. It is thus possible to analyze more accurately where and how many animals there are, and specific conclusions may be drawn for influencing the animal traffic.

According to another advantageous embodiment, the number of animals in at least one recording region is recorded optically by a camera system. This is advantageous inter alia since retrofitting is possible without great expense in an agricultural concern. At least one camera needs to be installed at a place from which the region to be recorded is visible. This camera is signal-connected to the data processing system.

According to another advantageous embodiment, the number of animals in at least one recording region is ascertained with the aid of an animal detection device. This may be done as an alternative or in addition to the recording by means of a camera system. The animal detection device may be formed by an animal detection unit in combination with an animal-specific identification means, which each animal wears. This may be an element capable of wireless signal connection, for example a GPS or radio transmitter. RFID systems and further variants are possible. An animal identification means may be worn by an animal on the ear, around the neck or on an ankle. An advantage of this embodiment of the invention is that it allows not only general recording of the animal density but also position determination of each individual animal. For this purpose, at least one animal detection unit that can record a signal of an animal identification means needs to be installed at a suitable location. The data collected may then be sent to the data processing system and processed there.

According to another advantageous embodiment, an animal density may be ascertained with the aid of treading sensors. Treading sensors are suitable and intended for ascertaining a number of loading events (stresses) and/or a load level. A probable number of animals in the recording region may be deduced therefrom by a data processing system. This recording method may be used as an alternative or in addition to the methods described above.

According to another advantageous embodiment, the acquired data are provided to the control device of a cow driver. Thus, on the basis of the data obtained by recording the animals, not only a setpoint opening extent but also an operating characteristic, and in particular a rate of advance of the cow driver, may be adapted. A particular advantage of this is also that it is possible to respond to incidents by stopping or retracting the cow driver. Conventionally, cow drivers are often moved at a constant speed. If a cow is prevented from going in the forward direction, for example, a continuously moved cow driver may injure the animal. With the aid of the animal density recording and the coupling with the controller of the cow driver, this risk may be minimized.

According to another advantageous embodiment, the acquired data are provided to the control device of a milking carousel. In this way, a rotational speed of the milking carousel may also be adjusted as a function of the recorded data. Furthermore, it is possible to pause the milking carousel if predeterminable limit values should be exceeded or if there should be a drop below them.

A further concept of the invention proposes a milking installation which comprises a holding area, a milking parlor, a passage connecting the holding area to the milking parlor, a steering unit arranged in the passage, a control device for the steering unit and a data processing system. The holding area comprises at least one recording region, in which at least one recording unit is provided. In this milking installation, the opening extent of the steering unit can be determined with the aid of the data that are obtained by a recording unit. These parameters may, for example, be the animal density per defined area or products calculable therefrom.

A recording region comprises the transition region between the holding area and the passage. Advantageously, at least one further recording region is provided, in which further data are obtained.

According to another advantageous embodiment, the milking installation comprises a camera system which optically records the position of animals and transmits it to the data processing system. An image of backup areas and free spaces may be compiled from the position of individual animals and operating procedures may be adapted to the situation.

According to one advantageous embodiment, the milking installation comprises at least one animal detection unit which is suitable and intended for recording the position of animal-specific identification means and transmitting it to the data processing system.

According to another advantageous embodiment, the floor of at least one subregion of the milking installation is equipped at least partially with treading sensors, with the aid of which an animal density can be ascertained.

According to one advantageous embodiment, the milking installation comprises a cow driver which can be moved. It may be configured in the manner of a grid. Advantageously, the acquired data are provided to a control device of the cow driver so that the operating characteristic and rate of advance of the cow driver can be automatically adapted on the basis of these data.

According to one advantageous embodiment, the milking installation comprises a milking carousel, the rotational speed of which can be adapted on the basis of the recorded and processed data.

Further advantages and details of the invention and the technical context will be explained in more detail with the aid of the figures. The figures show particularly preferred procedures and exemplary embodiments, although the invention is not limited to these. In particular, unless otherwise explicitly explained, it is also possible to extract partial aspects of the subject matter explained in the figures and combine them with other constituent parts and findings from the present description and/or figures. In particular, it should be pointed out that the figures, and in particular the size ratios represented, are only schematic. Identical reference signs denote identical objects, so that explanations from other figures may also be consulted if appropriate.

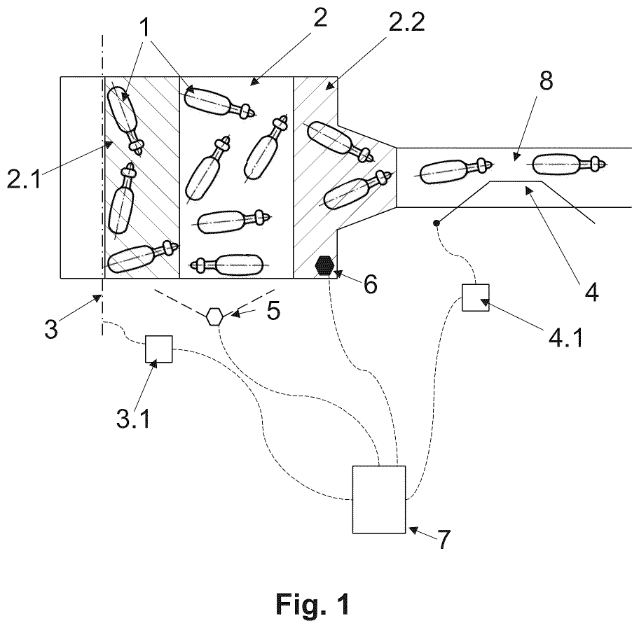

FIG. 1: shows a plan view of a holding area and passage equipped with components according to the invention

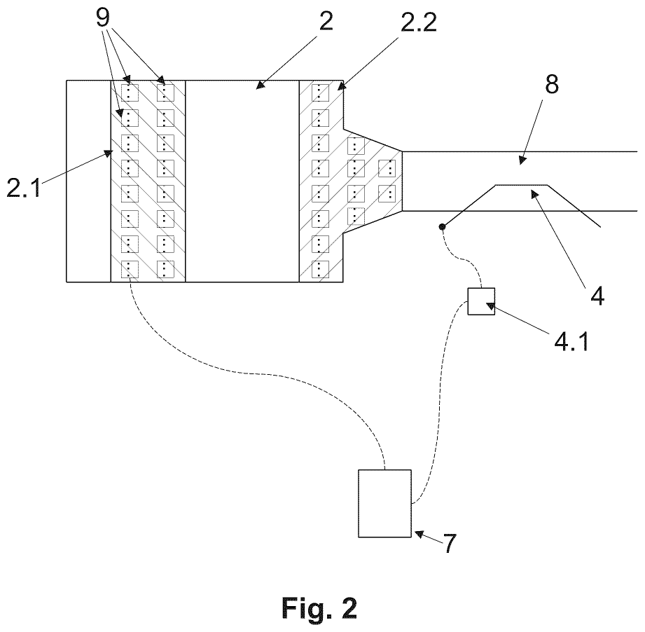

FIG. 2: shows a plan view of an alternatively configured holding area and passage

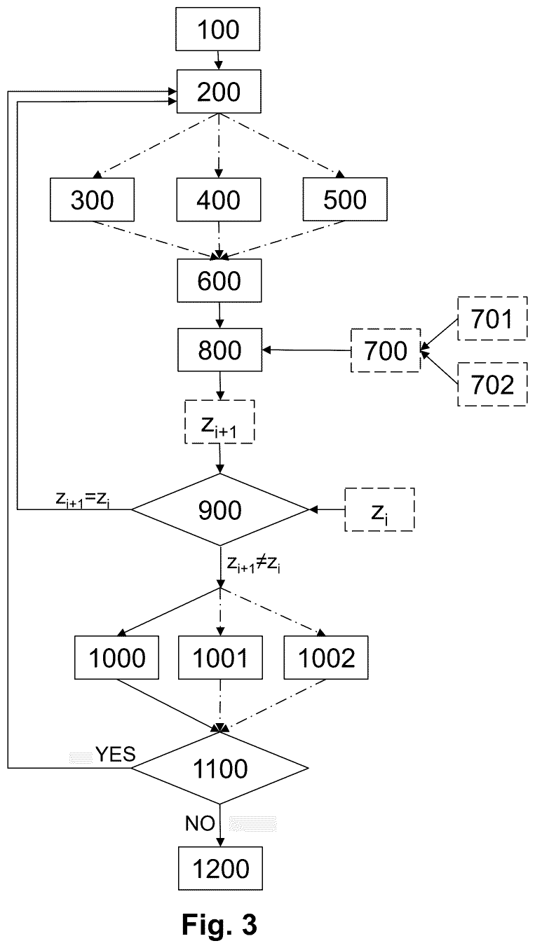

FIG. 3: shows a flowchart to illustrate the process steps of a method according to the invention.

FIG. 1 shows a holding area 2 in which there are a plurality of animals 1, which may be cows. The holding area 2 may for example be a collecting region for waiting animals 1 in front of a milking carousel or group milking parlor. A cow driver 3 is arranged in the holding area 2. It may be in the form of a grid and movable, and is suitable and intended for driving the animals 1 in one direction by it being moved in this direction. The cow driver 3 extends at least over the entire width of the holding area 2, so that animals 1 cannot move back by passing to the side of the cow driver 3. The cow driver 3 is connected to a control device 3.1, by means of which a rate of advance of the cow driver 3 can be adjusted. The control device 3.1 is signal-connected to a data processing system 7.

The holding area 2 may have a plurality of recording regions 2.1, 2.2. In this exemplary embodiment, two recording regions 2.1 and 2.2 are shown. The recording region 2.1 is arranged on a space in front of the cow driver 3 in the direction of a passage 8. In the situation represented, there are three animals 1 in the recording region 2.1. The recording region 2.2 extends over the region of the transition from the holding area 2 to the passage 8. In the situation represented, there are two animals 1 in the recording region 2.2.

A passage 8 is formed following on from the holding area 2. It may for example be the access to a milking carousel. The width of the passage 8 is variable. This is achieved by a steering unit 4. The steering unit 4 is formed by a frame-like construction, the position of which can be adjusted by means of a control device 4.1. The control device 4.1 is signal-connected to the data processing system 7.

A camera system 5 is positioned in such a way that the holding area 2 is visible. For this purpose, one or more cameras may be provided. Optical recording of the number of animals 1 in the holding area 2 can take place by the camera system 5.

An animal detection unit 6 is installed in the holding area 2. Each animal 1 may be equipped with an identification means, for example a GPS transmitter, from which position data are transmitted to the animal detection unit 6. The identification means may be worn by each animal 1, for example on the ear, neck or an ankle. With the aid of the position data of each animal 1, it is possible to ascertain in which recording region 2.1, 2.2 animals 1 are present and how many animals 1 are present in them.

Both the camera system 5 and the animal detection unit 6 are signal-connected to a data processing system 7. The data processing system 7 may calculate a suitable rate of advance of the cow driver 3 and/or an adjustment of the steering unit 4 from the received data. In order to control the cow driver 3 and the steering unit 4, the data processing system 7 is signal-connected to the respective control devices 3.1 and 4.1.

FIG. 2 is a plan view of a holding area 2. It differs from the embodiment of FIG. 1 in respect of the recording unit provided for recording animals. In addition, a cow driver 3 is not provided. For better clarity, no animals 1 are shown in FIG. 2. In other regards, reference is made to the explanations of FIG. 1.

The holding area 2 has a plurality of treading sensors. In the exemplary embodiment shown, these are represented in the form of treading sensor plates 9. A treading sensor plate 9 can detect the frequency or load level of loadings, or treading events, and store this or transmit this to a data processing system 7.

A plurality of treading sensor plates 9 therefore deliver a data basis from which a number and/or a weight of animals 1 may be deduced. In the exemplary embodiment shown, a plurality of rows of treading sensor plates 9 arranged equidistantly from one another are respectively provided in the recording regions 2.1 and 2.2. This arrangement is an example. It would also be possible to equip at least a part of the floor continuously with treading sensor plates 9 or to use a larger or smaller number of treading sensor plates 9 than shown in FIG. 2. When more treading sensors or treading sensor plates 9 are provided, the data basis from which an animal number or animal density can be calculated is commensurately more reliable. An equidistant arrangement of the treading sensor plates 9 is preferred.

FIG. 3 represents a method according to the invention with the aid of a flowchart. Method steps are represented in rectangles with solid borders, and parameters are represented in rectangles with dashed borders. Decision processes are represented in diamonds. Method steps that may optionally be carried out are connected to other method steps by arrows having dot-and-dash lines. Method steps that must be carried out are connected to other method steps by arrows having solid lines.

After the process start 100, the recording region 200 is defined. The recording region 2.1, 2.2 is the area on which a number of animals 1, or an animal density, is intended to be recorded. This may, for example, be part of a holding yard 2 in front of a milking carousel. There are three options for the recording method, which may be used individually or in combination. In the case of recording by means of a camera system 300, a number of animals 1 is recorded optically by one or more cameras. Recording with an animal detection unit 400 is carried out by each animal 1 wearing an individual identification means that is recorded by the animal detection unit 6, so that conclusions may be drawn relating to a number of animals 1 in the recording region 2.1, 2.2. Furthermore, as an alternative or in addition, recording may take place by means of treading sensors 500. For this purpose, a recording region 2.1, 2.2 may be equipped with treading sensors, or treading sensor plates 9, which record loading events and/or loading levels. A number of animals 1 can be ascertained therefrom.

After at least one of the recording methods 300, 400 and 500 has been carried out, an animal-specific parameter is ascertained in a further step 600.

These are computed in a data processing step 800 with installation parameters 700. An installation parameter may be a rotational speed 701 of a milking carousel or a rate of advance 702 of a cow driver. A setpoint opening extent zᵢ₊₁ of a passage barrier is calculated therefrom. In step 900, the setpoint opening extent zᵢ₊₁ is compared with the actual opening extent zi, which is transmitted to the system for this step.

If the setpoint opening extent zᵢ₊₁ and actual opening extent zᵢ are equal, or if the difference between them lies within a predeterminable tolerance, the process is repeated from step 200, the definition of a recording region. If the setpoint opening extent zᵢ₊₁ and actual opening extent zᵢ differ by more than the predeterminable tolerance, at least one of the process steps 1000, 1001 and 1002 is carried out.

During an adjustment of the steering unit 1000, a setpoint opening extent Zi+1 is transmitted to the control device of the steering unit 4.1 and is adjusted.

As an alternative or in addition, process step 1001, an adaptation of the rotational speed of a milking carousel, may take place. This may, in particular, be done when there are so many animals 1 in the at least one recording region 2.1, 2.2 that simple regulation of the opening extent of the steering unit is not sufficient to ease the situation.

Furthermore, as an alternative or in addition, the rate of advance of a cow driver 1002 may be adapted. One possible scenario in which this measure might be expedient could be individual animals 1 remaining in at least one of the recording regions 2.1, 2.2. The animals 1 may thus be made to leave the regions with the aid of the cow driver 3 in order to reach an end of the milking process.

Following this, in process step 1100, a query is made as to whether there is at least one further animal 1 in one of the recording regions 2.1, 2.2. If the answer to the query is negative, the process end 1200 is reached. If there is still at least one animal 1 in at least one of the recording regions 2.1, 2.2, the process step is continued with step 200, a definition (possibly to be adapted) of the at least one recording region 2.1, 2.2. These steps are repeated until the answer to the query 1100 is negative and the process end 1200 is finally reached.

After the process end 1200, the steering unit 4 is preferably brought into a predeterminable end position, which may be ascertained by the data processing system 7 while taking into account empirical values and/or the recorded animal-specific data.

The invention relates to a method for influencing the traffic flow of animals, which proceeds at least semi-automatically, and to a milking installation which has the method features. As a function of the animal density in at least one predeterminable recording region, according to the invention a steering unit that allows, facilitates or prevents transit of the animals through a passage is automatically adjusted. According to advantageous embodiments, the operation of a cow driver and of a milking carousel is also influenced on the basis of the recorded data.

### LIST OF REFERENCE SIGNS

1 animal
2 holding area
2.1 recording region 1
2.2 recording region 2
3 cow driver
3.1 control device of the cow driver
4 steering unit
4.1 control device of the steering unit
5 camera system
6 animal detection unit
7 data processing system
8 passage
9 treading sensor plate
100 process start
200 definition of the recording region
300 recording by means of camera system
400 recording by means of animal detection unit
500 recording by means of treading sensors
600 acquisition of animal-specific parameters
700 installation parameter
701 rotational speed
702 rate of advance of cow driver
800 data processing
900 comparison of parameters zi and Zᵢ₊₁
1000 adjustment of the steering unit
1001 adaptation of rotational speed
1002 adaptation of rate of advance of cow driver
1100 query as to whether there is at least one animal in the recording region
1200 process end
Zᵢ actual opening extent
Zᵢ₊₁ setpoint opening extent

1. A method for influencing a traffic flow of animals from a holding area into an adjacent passage which has a steering unit, wherein the holding area has at least one recording region with at least one recording unit, comprising the following method steps:
recording a number of animals in the at least one recording region by the at least one recording unit,
determining a setpoint opening extent of the steering unit based on the recorded number of animals,
comparing the setpoint opening extent with an actual opening extent of the steering unit, wherein
above a predeterminable difference between the setpoint opening extent and the actual opening extents of the steering unit, the method further comprises issuing a command to a control device of the steering unit and moving the steering unit to the setpoint opening extent,
so that a width of the passage is varied based on an opening extent of the steering unit.

2. The method as claimed in claim 1, wherein the at least one recording unit records at least one of a length, width or mass of each animal, and wherein the method further comprises determining the setpoint opening extent of the steering unit based at least in part on the recorded length, width, or mass of each animal.

3. The method as claimed in claim 1, wherein the holding area has a transition region, which forms a recording region of the at least one recording region, next to the passage.

4. The method as claimed in claim 1, wherein the at least one recording unit includes a recording unit formed by an optical recording system, in particular by a camera system.

5. The method as claimed claim 1, wherein the at least one recording unit includes a recording unit formed by an animal detection device comprising one identification means per animal and at least one animal detection unit.

6. The method as claimed in claim 1, wherein the at least one recording unit includes a recording unit formed by treading sensors.

7. The method as claimed in claim 1, wherein the animals are driven by a cow driver in the direction of the passage.

8. The method as claimed in claim 7, wherein the acquired data of the at least one recording unit are provided to a control device of the cow driver.

9. The method as claimed claim 8, wherein the acquired data of the at least one recording unit are provided to the control device of a milking parlor.

10. The method as claimed in claim 9, wherein the milking parlor is arranged on a milking carousel and wherein the method further comprises adapting a rotational speed of the milking carousel as a function of the acquired data of the at least one recording unit.

11. A milking installation comprising a holding area, a milking parlor, a passage connecting the holding area to the milking parlor, a steering unit arranged in the passage, a data processing system and a control device for the steering unit, wherein
the holding area has at least one recording region with a recording unit,
the control device and the recording unit are signal-connected to the data processing system, and
an opening extent of the steering unit, which influences a width of the passage, can be varied by the control device.

12. The milking installation as claimed in claim 11, wherein the holding area has a transition region, which forms a recording region of the at least one recording region, next to the passage.

13. The milking installation as claimed in claim 11, wherein the recording unit is formed by an optical recording system, in particular by a camera system.

14. The milking installation as claimed in claim 11, wherein the recording unit is formed by an animal detection device comprising one identification device means per animal and at least one animal detection unit.

15. The milking installation as claimed in claim 11, wherein the recording unit is formed by treading sensors, which are signal-connected to the data processing system.

16. The milking installation as claimed in claim 11, further comprising a cow driver, which is arranged in the holding area for driving animals in the direction of the passage.

17. The milking installation as claimed in claim 16, wherein acquired data of the recording unit are provided to a control device of the cow driver.

18. The milking installation as claimed in claim 11, wherein the milking parlor is arranged on a milking carousel and the milking carousel is constructed and arranged to adapt its rotational speed as a function of the acquired data.
